(19) United States
(12) Patent Application Publication
(10) Pub. No.: US 2003/0217171 A1
(43) Pub. Date: Nov. 20, 2003

(54) Self-replicating and self-installing software apparatus

(76) Inventors: Wolfgang R. Von Stuermer, New York, NY (US); Jon Zimmerman, San Francisco, CA (US)

Correspondence Address: PILLSBURY WINTHROP, LLP, P.O. BOX 10500, MCLEAN, VA, 22102, US

(21) Appl. No.: 10/440,387

(22) Filed: May 17, 2003

Related U.S. Application Data
(60) Provisional application No. 60/381,458, filed on May 17, 2002.

(51) Int. Cl. G06F 15/16

(52) U.S. Cl. 709/231

(57) ABSTRACT

Self-replicating and self-installing software apparatus for content-creation, manipulation, and static or dynamic exhibition with a self-regulating license management component with methods for remote controlled and synchronized functionality and license binding to a Peer-to-Peer computing paradigm derived communication and collaboration platform's unique User ID.

### RELATED APPLICATIONS

This application claims the benefit of U.S. Provisional Application No. 60/381,458 filed May 17, 2002 from which priority is claimed and the disclosure of which is herein incorporated by reference.

### BACKGROUND OF THE INVENTION

1. Field of the Invention

This invention relates generally to digital media file streaming, sharing, review, and creation in a Peer-to-Peer collaborative technology environment.

More particularly the invention relates to sharing and reviewing, which can be the static or dynamic sharing, in form of streaming and creating digital media, such as data, images, video movies and sound files in a collaborative fashion within a Peer-to-Peer collaborative product or platform, which can also be a wireless device.

2. Description of the Related Art

The technical background of this tool begins with the advent and use of the Internet and digital communication and media becoming widespread and commonplace, observations of new ways of incorporating these digital tools into the workplace are coming to light. Digital media and the Internet in its ubiquity are providing developers and reviewers of content new opportunities to work together. The Internet although a huge invention in many accounts is by no means complete. The World Wide Web allows data transmission to occur over the Internet efficiently but in many cases its largely client-server based architecture, does not allow for easy, synchronous or nearly synchronous media review and control of playback between different parties. Peer-to-Peer (P2P) is a new generation of Internet based technology, which states that each node on a network of computers is both a client and a server. This generation of technology, rather than trying to create efficiencies at each point in the network by centralizing computing, storage and transmission power, instead harnesses the abundance of commodity level processors, storage devices, and Internet connections.

The behavioral background of the presently disclosed invention may begin with the physical playback, review, and creation of media. Since humans have begun collaborating on permanent (semi-permanent) content, whether a painting on a wall, recording early big bands, or making films, humans have had to gather physically together to use more than one sense in a near realtime fashion to review media. With the advent of closed circuit television, and telephone usage, humans have been able to see and hear each other while in remote locations. Although they have been able to see each other, the tools where not presenting real media as they are simulated visualizations on some form of electronic display.

Since Digital tools are reviewed on television or other projected image devices, two users in remote locations can effectively use the same tool together reviewing or working on the same piece of content. In the digital world, since everything is made of binary code, two files can exist which are absolutely identical in every way except for the fact that they reside in two physically different places. Therefore two viewers can see exactly the same piece of content in two different places. Digital technology allows for remote humans to review and work on exactly the same digital files that are not facsimiles of each other. This provides no error that any of the reviewing parties will see something different from each other as each digital file is identical.

MediaTeam merges both of these advances to allow computer users in remote locations to store, review, edit, save and remark on digital content in near realtime. Since all participants who have agreed to a MediaTeam session have exact copies of the system installed and any data (media or otherwise) is stored and mirrored to the other participants, they are all working on the same content together enabled by the computing paradigm of P2P technology. Since data (applications' code and content) developed for P2P systems can be transported from one user to another within the P2P network, making sure that each user has a paid license has been difficult due to the fact that each machine can copy its contents to another machine without centralized registration and control. The system may take this into account by incorporating a licensing system that locally checks its state based on a current application status as indicated and stored in a license information data container (a local file or data stored on a web server or OS related key setting) and by binding the license status information with the unique user ID a user is required to create in order to be able to use the underlying P2P collaboration application in which the system is operating. Periodically, or upon certain user or application internal or external events the system will need to connect to the Internet to check its license state with a central license authorizing server, which will verify the users license status.

Definitions

Shared realm, space: A shared realm would be the private or public “virtual location” where peer users (“members”) interact. It could contain one or more embedded applications, and maintain data corresponding to the current state of each interaction. The persistent version of a shared space could be a document database. To make it shared, identical copies of this database could be stored on each user's computer, and all copies are constantly updated so they always define the current state of the shared realm. Documents in this database could contain a list of every peer user of the shared realm, with automatic detection of which peers are active, which embedded application they are using, and the current state of all of the shared realm's data.

User, peer user, member: A member is an entity who interacts with the other members within a shared realm. This can be a person, a computer, or any other entity that can interact with the other peers. Members interact through devices (usually computers) just as people on the phone interact through their telephones.

Embedded Application: An embedded application is the “program” or shared application that members use to interact with the context of a shared realm. The system may constitute an Instance of an embedded application. Each member of a shared realm has access to the same embedded applications, and can use them to affect the shared data.

View: A view is typically one or more user interface components that capture user input and request that the underlying engine generate traceable units of change to represent that input. The view queries the engine for data. An embedded application can subscribe to another embedded application's view, but does not need to provide a view.

Engine: An embedded application's engine is responsible for maintaining and changing the data model (the application's persistence). An engine creates and executes units of change on behalf of the view and acts on change units received from other embedded applications of a shared realm. An engine provides units of change asynchronously to the tool.

Controlling code: Embedded application code components constitute the controlling code that make the engine, view, and rest of the application fit together as a component collection and function as an application, thus giving the embedded application its appearance, behaviors, and functionality.

User Account: An account is a type of special-purpose shared realm in which information about the user is stored. This information includes a list of the user's identities, realms and contacts.

User Identity: Every user of a P2P collaboration platform has at least one identity, and may have many identities. The default identity is the user account name. An identity is a collection of data that corresponds to one persona of the user. Example data may include a P2P platform identity URI, a virtual business card (vCard), and relevant security information. An identity is the part of an endpoint that identifies who is doing the interacting. Identity may be specified via a globally unique computer generated Identity URL. A user's account would contain a collection of a given user's identity data.

Endpoint: An endpoint is a combination of an identity and a device (who and what). Endpoints referring to the same person could be “Her on her PC at work” or “Him on his PDA at home”. An Endpoint allows a P2P collaboration platform to identify a person among multiple users of the same device, and to identify a device among multiple devices used by one individual.

GUID: Globally Unique IDentifier. GUIDs may be used to specify unique objects.

Skin: Skins could be sets of usually graphical and/or functional components that may influence or define the appearance and behavior of a P2P platform's controller and embedded applications.

Relay: A P2P collaboration platform's relay or relay service would be an intermediary device that relays data between members and store units of change for users that are not online and provides “fan-out” distribution of units of change.

RVP: RVP is the Rendez-Vous protocol. This is a developing standard for locating and contacting people over networks

SSTP: SSTP (Simple Symmetrical Transmission Protocol) is a small, application-layer protocol designed to allow two programs to engage in bi-directional, asynchronous communication over both TCP and UDP protocols.

DPP: DPP (Device Presence Protocol), which provides a “source” client's Communications Subsystem sufficient information so that it can transmit information to a “destination” client along the best possible path. It can also notify the source client if a destination client is currently available for live SSTP service, whether directly or indirectly.

P2P Pure and Hybrid: A pure P2P system does not contain a centralized management server or component of any type. A Hybrid P2P system may utilize a centralized management server or component for any number of reasons.

### SUMMARY OF THE INVENTION

The invention solves many of the issues of near-synchronous reviewing of media with groups of people over the Internet with current Internet protocols and technology. The invention was designed to utilize many of the core data communication, storage, dissemination and encryption abilities of Peer-to-Peer collaboration application frameworks to enable collaborative digital media review over the Internet. One way of distributing the invention is by utilizing an Internet based licensing system that binds the license information with unique P2P framework user ID from which the invention can be purchased, downloaded and, upgraded automatically, with the only user intervention being to provide a credit card number to the licensing system website and entering the gained license authentication information into the application. In one embodiment the system is initially provided to an end user with all of the currently offered functionality included, but some functionality may be hidden based on which specific product version has been purchased. This information is captured in an external license information storage container. Auxiliary functionality, provided in future updates and upgrades, will allow the invention's users even more communication features as well as direct streaming, co-editing and encryption tools.

Based on P2P (Pure and Hybrid 105) technology: The invention is designed to take advantage of P2P technology allowing digital communication from the invention to be transported by P2P enabled collaboration platforms to other invention users in many cases directly and not in client-server computing paradigm according to P2P communication theory.

The system may be realized and intended to be used as an embedded application on or within any P2P communication and/or collaboration platform or any communication or collaborative usage device, which can include but need not a centralized server for: directory look-up, as a traffic relay manager, a enterprise connection server, or any other centralized computer system. A P2P collaboration platform may provide for applications to be “hot-deployed” (i.e. installed while running without the need to restart a base application or a computer) to other users by invitation to collaborate together. FIG. 3 depicts various ways in which end users on various digitally enabled devices could be connected and collaborating with each other within the context of a P2P collaboration environment. Circles highlight users where the invention is installed and in use. These users can be part of a local area network (LAN) and/or behind a firewall or users on an open network, which can be a wireless, or wide area network (WAN) or the Internet. The current example platform allows individuals whether they are behind a firewall, a unique user, one of a small cluster, or a wireless device to be able to communicate with each other.

The P2P collaboration platform can provide for the collection, storage, consolidation, protection, encryption and management of end users' data under the concept and definition of realms, members, identities or user accounts as drawn in FIG. 5. It further can enable groups of end users to consolidate shared work and data that goes with the shared work under the concept of a virtual room, community, space, or area.

Various components of the P2P collaboration platform can interact and relate to fundamental building blocks of a P2P collaboration system as drawn in FIG. 2. The P2P system provides ways to determine whether a user is active or online within the context of the P2P system, therefore detect his online “presence”. This detection of a user's online presence may allow the P2P collaboration to spontaneously “invite” or ask a known user that is online into the realm of another user's current or asynchronous activity—making them join each other in a virtual “room” or “space”. A collective grouping of these “invited” or “asked to join” users may also be called a “community”. An applicable P2P collaboration environment in which the invention is designed to operate in provides the necessary means and mechanism to create, identify and disseminate such notes of invitation as well as the provisioning for the concept of the virtual room in which all data and applications get placed or operate. A high-level overview of aspects of detection that would need to be observed in a applicable P2P deployment system is drawn in FIG. 8.

The P2P collaboration platform can provide for collaborative file sharing in that each invited or uninvited participant's computer will have duplicate files stored locally for quick local review and editing. This P2P collaboration system may allow for file updates to be made in whole or with the addition and change of data that is in the changed data delta. The P2P collaboration platform may allow for varied ways of two-way communication including but not limited to: Chat/Instant Messaging, VoIP, threaded discussions, and video conferencing. The P2P collaboration platform may include functionality, which enables file changes to be made on outside applications and communicated to other users through the collaboration platform's messaging technology.

In another general aspect, the invention may be deployed on a variety of communication or collaboration platforms that resemble or embrace a P2P usage paradigm and require or are based on all or one of the following operating systems to operate: Microsoft Windows or any Microsoft OS product, an Apple operating system, LINUX or any variant of this UNIX alike operating system, UNIX or any variant of the UNIX operating systems, or personal handheld assistants or mobile devices or phones operating systems (e.g. J2ME, BREW, PalmOS, Symbian, Microsoft CE, 802.11 protocol, aka WI-FI). This communication and/or collaboration platform may include distributed components originally written in C, Basic (incl. Visual Basic and Visual Basic.NET), C#, C++ (incl. Visual C++ and Visual C++ .NET and Microsoft CE .NET), Pascal (inc. Delphi), Cobol, Fortran, .NET (incl. ASP.NET), XML or derivates hereof, BREW, Symbian, PalmOS or Java (incl. Java2, J2EE, J2ME) code. It may utilize components that adhere and are subject to the specifications and concepts of Interface development contracts of COM, COM+, DCOM, EJB, CORBA or .NET and are distributed to an end user in form of source code, object code, XML payload or compiled binary form.

In another general aspect, a system for deploying MediaTeam may include a computer workstation, super-computer, Personal Digital Assistant, or mobile phone, or any combination thereof. An input device and display device will be included in a deployment.

In another general aspect, the data transportation between the different users' copies of the invention may occur over traditional cable and wire transmission technologies, but also over radio, infrared or any other waveform of the electromagnetic spectrum as well as gravitational, or any other type of field modification waves, and any airborne, ground-based, optical or aquatic-based data transmission mechanisms.

The invention is comprised of proprietary and/or off-the-shelf 3^{rd} party software components that are written partly or as a whole in or with programming languages that match the programming languages [13] that constitute the target deployment P2P application platform framework. In all instances, the invention is not a single digital file to be distributed, but rather comprised of a package of conceptually interconnected digital files to be distributed as a whole or selectively as individual files, referred to as a distribution package.

Digital media streaming, review, editing, and encoding components: The invention utilizes software components that enable digital media files to be decoded and reviewed on the user's usage devices. The invention includes software components that allow digital media to be streamed and or edited in ways including but not limited to, cutting, pasting, equalizing, synthesizing, reversing, and shifting or modifying pitch or color. The invention includes software components that allow for digital media to be encoded or re-encoded into software codec schemes and then saved.

The invention is provided with network (or electronic distribution) enabled software licensing system that is embedded within or deployed external to the core invention's functionality and statically bound to a user's unique account or device identity information that is registered or advertised to other users within the context of a shared realm, and which will allow it to self-unlock or lock new functionality transparently or with intervention of the user. The licensing technology allows the proper functionality to be unlocked or locked depending on how the invention was downloaded to the local user and whether they had paid for it or not. The invention's internal code sets the functionality to a default Preview state, if there is no appropriate unlocking key available for other user modes. Functionality unlocking keys can be purchased from the manufacturer or a reseller of the invention. Users are able to purchase keys for one or many individual P2P collaboration platform user members, accounts or identities (see above definition of possible P2P collaboration platforms and applied concepts of grouping of users' data [10]) at one time. The software licensing system is composed of a two part environment; local to a specific usage device that manages functionality usage based on a local key state and a (automated) license management system that resides on the Internet. This system includes all account management, user profiles, and purchasing technology and information. It provides the user, under the circumstances of being a fully validated and authorized user who purchased the invention, with the correct key in an automated, seamless data transmission process, whereby it communicates with the license state information container residing on the users usage devices or on the Internet and send the appropriate key. The licensing software on the user's usage devices periodically on its own, or triggered by user driven or external events, communicate with the license management system to make sure the user's account is current. Should the current user be intermittently identified by the system has having switched states to become an unauthorized user, at the moment of returning the results of the status check, the invention can be switched into the default preview mode. Software disablement or any other appropriate action as defined in the code of the invention can be taken.

Auxiliary software components: MediaTeam is comprised of other software components in conjunction with collaborative accessible media review that could but will not be limited to technology such as: threaded discussion, document presentation, video & audio editing, video and audio equalization, white-boarding, video conferencing, still image review and mark-up, compression-decompression, Internet uploading and downloading, web-page review, VRML, 3D modeling and animation technology, VoIP conferencing technology, media streaming technology. These software components can or cannot be physically included in the software, but represented through a “thin” interface, with the actual code residing elsewhere on the local computer or on a remote computer. These software components may control local or remote audio and/or video related hardware including but not limited to: CD Jukeboxes, TV and Audio broadcasting equipment (VHF, UHF), mobile personal digital assistants and mobile phones, Video and Audio playback devices, recording, playback, and storage devices and media DAT, VHS, DVD, BetaMAX, magnetic tape, CD, CD-ROM, or film, Remote Camera and microphone control, robotic armature, or machinery that produces media of any type.

Usage modes: Tool functionality and behavior: The invention and its provided functionality currently has two or more core usage modes: Local Review 035 and Team Review 036. The Local Review mode restricts many media file events to the local invention instance on the user's usage device. Team Review mode allows media file and control events to occur in a synchronous or near synchronous manner on all the selected participants' usage devices remotely. Auxiliary functionality or software components can or cannot be subject to the two modes. Further functionality will be set by various types of defined tool behavior when more than one user is working with the tool, in a collaborative manner. Which functionality the user has access to in each mode will depend on the license scheme that they have.

Other features and advantages are apparent from the description, the drawings, and the claims.

### BRIEF DESCRIPTION OF DRAWINGS

The invention and its advantages will be more readily apparent to those skilled in the art by reference to the detailed description provided herein below when considered in connection with the accompanying drawings, wherein:

FIG. 1 is a schematic of the invention's software components showing the hierarchical layers on which the invention is built upon in an exemplary deployment environment.

FIG. 2 is an interaction chart illustrating how fundamental components (e.g., identify representation, data persistence, application data) of an applicable collaboration platform

FIG. 3 is a high-level network diagram that depicts how collaborating users could be connected using various communication devices in an applicable collaboration platform.

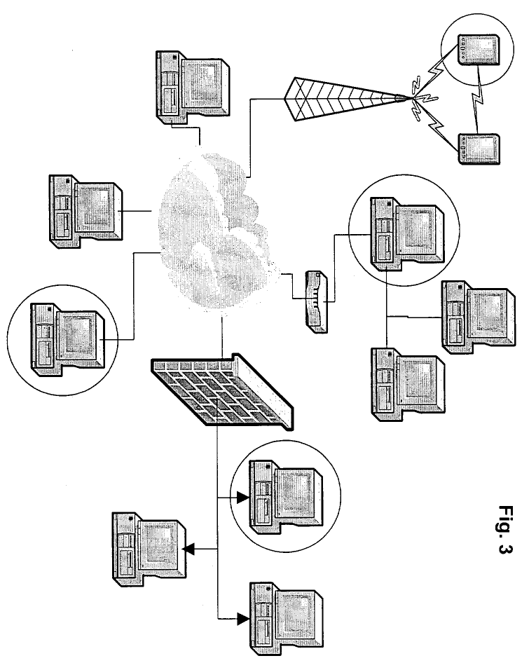

FIG. 4 is a relationship diagram showing a conceptual grouping of service types in an applicable collaboration platform.

FIG. 5 is a schematic of the collection, storage, encryption and management of end users' data in an applicable collaboration platform showing the concept and definition of devices, identities and accounts.

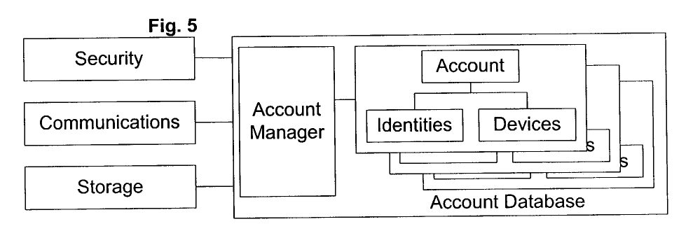

FIG. 6 is a schematic of data storage model of an applicable collaboration platform showing the relationship between an XML API and a proprietary collaboration platform API.

FIG. 7 is a schematic of a possible installation management system of an applicable collaboration platform showing a variety of components managing installation versions of the invention's distribution package.

FIG. 8 is a high-level relationship diagram of a presence detection service and related protocols useful for the invention in an applicable collaboration environment showing the abstraction layers of an applicable presence service detecting LAM or WAN user presence.

### DETAILED DESCRIPTION OF EMBODIMENTS OF THE INVENTION

Distribution of the invention: In all instances, the invention is not a single digital file to be distributed, but rather comprised of a package of conceptually interconnected digital files to be distributed as a whole or selectively as individual files, referred to as a distribution package. A distribution package consists out of files of which some are meant to run on an end-user's computer system, within a P2P collaboration application framework, and/or off the Internet. The distribution package may contain license information storage containers or it may be programmed to generate such containers and populate them with default license status information.

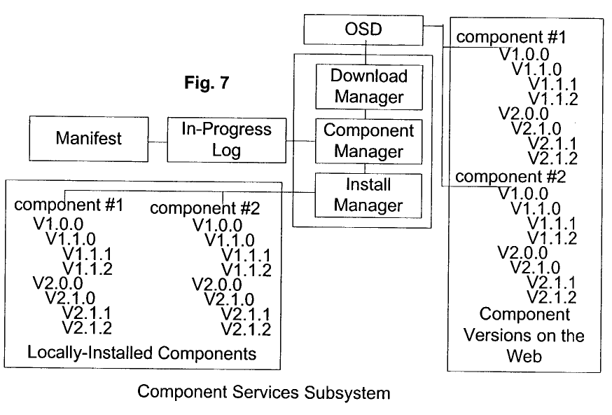

Installation of the packaged files constituting the invention can be handled by a custom installation mechanism or may rely on installation processes as they are defined by an underlying computer operating system and/or the P2P collaboration system. The FIG. 7 outlines how a applicable installation management system can handle the installation and version management of versions of the distribution package.

The distribution package may be delivered to an end user in either form 025, 026 of the distribution mechanism or as a combination hereof.

Distribution via a non-physical medium: The invention's distribution package will be distributed by way of electronically copying the distribution package's digital contents onto an end-users digital persistent storage medium, which may be a computer hard-disk, Flash-ROM or any other type of rewrite-able digital storage. The electronic distribution channel may consist out of closed Local Area Networks, Wide Area Networks, or open networks such as the Internet or wireless networks.

Distribution via physical digital media: The invention's distribution package can be delivered to an end user by way of making physical digital storage media available. This may include CD-ROMs, CDR & DVD media, floppy disks, data tape, Flash-ROM, EPROM or others. The data contained on a physical medium can be just a portion of the full distribution package with instructions and/or code of how to retrieve the remainder of the distribution package.

Architecture Building Blocks of the Invention

Overall Architecture: Integration with a P2P collaboration application framework and a license management system. As explained in the section ‘Distribution of the invention 022’, the invention is comprised of a set of conceptually interconnected digital files, where each resembles a single or a collection of components. Each file contains or describes one, or more than one component or object in human readable or binary form. Well defined application programming interfaces (APIs) for each of the components, enable them to exchange messages with other components to conduct the necessary internal communication between the components and the communication with the surrounding P2P collaboration framework and the underlying operating system.

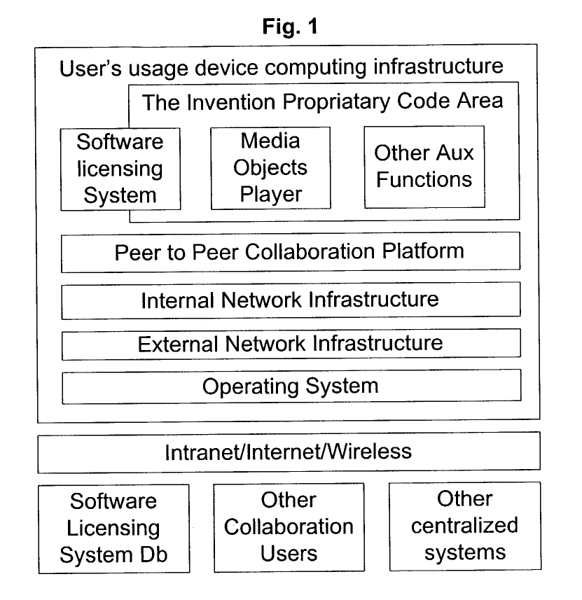

The different layers that constitute the invention within an example deployment environment are shown in FIG. 1: The topmost layer being the invention layer, is by itself comprised of a minimum of four major component blocks: one to handle the invention runtime mode determination, the local and remote licensing status determination and licensing management server automated electronic communication aspects; one to handle and automatically load necessary lower level components depending on the automatic recognition of the digital media type streamed or included for review; one multi-purpose component that can take on a variety of features and display functions, and one to bind them all together to enforce the invention application logic and behavior. At the same time, each of the major component blocks is comprised out of further lower level components. At all times during the runtime of the invention is a message flow enabled that conceptually connects each of the major components with the others and facilitates the communication with the encompassing P2P collaboration environment.

The invention stays consistent in its architecture with aspects of a Model-Controller-View (MCV) architecture model, as an application P2P collaboratve framework could support. In that regard, the binding major component of the invention may consist of execution code elements in a scripted or complied software programming language and an object-descriptive human readable markup language, such as HTML, XML, etc., or derivatives hereof, whereas the other components take on various responsibilities and tasks depending on which function they fulfill under the MCV paradigm.

Hence, the binding component is responsible largely for communicating with the underlying P2P application framework and the rendering of the majority of user interface manages and acts as traffic manager to internal messages, and messages from the media component to the underlying operation system, whereas the media component is responsible for enforcing the behavioral logic that comes with playing back a digital movie as well as the loading of digital media content into media display objects. An example is that a “Play” command is disabled until playback is stopped. (Further explanation about the playback control behavior of the invention is outlined below 034.) Further, the licensing component takes on the responsibility to communicate or store or read data out of a license information storage container or create one if one is present and to communicate electronically with an external Internet server to determine or modify license and invention usage status. It may then report the current license status to the other components directly or via the binding component to trigger appropriate feedback in the other components, such as the switching of user modes, the turning on/off of user interface items, the loading or unloading of digital media content or the beguinning or ending of streaming related information,or dialog based notification of the user. The auxiliary multi-purpose component takes on the responsibility to react to user or other component triggered events by displaying or managing appropriate secondary content or data, such as a threaded discussion topic or presentation materials.

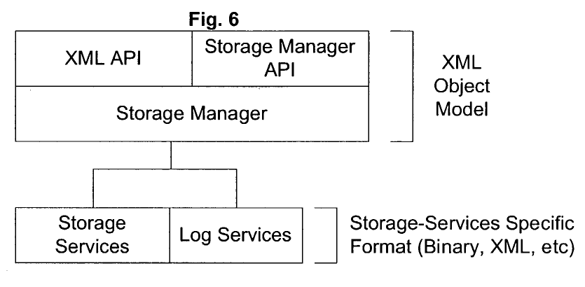

In its realization of the component communication the invention and the components of the invention make largely use of the protocol and data format infrastructure provided by the P2P collaboration system it is deployed within (such as COM, JMS, Corba or any other form of distributed component messaging) as well as commonly used networking or data exchange and transformation protocols such as TCP/IP (v4 & v6), HTTP, SOAP, JXTA, .NET, UDDI, RSS, XML, XSLT, XLINK, Web Services definitions, FTP, DPP, etc. It further makes use of data storage and property persistence mechanisms as provided by the P2P collaboration system and the underlying usage device operating system to store and manage the content and application status data that is required to perform the invention's application logic and media review process. FIG. 6 shows an example data storage model in which the invention is able to perform.

Method of applying and using available architecture mechanisms as previously described to achieve novelty in functionality: The invention's methods and use an underlying P2P system's data storage, presence and communication mechanisms to persist, synchronize and disseminate shared data and its own application logic's properties amongst simultaneously connected users, achieves collective application status and media display rendering knowledge, which allows for the realization of one user or multiple users ability to remotely control the display status of the media to be reviewed on other users' invention installation instances. This is a novelty.

Invention User Interface behavior: An important part of the invention is the user interface and the functionality the invention exposes to a user that enables him to trigger events and cause the underlying invention components to perform to related reactions and behaviors. Assuming fully licensed status, the invention works initially in two user modes 035 and 036 which the user can choose from. Further user modes can be defined. The setting of the user modes has different effects on the control of digital media playback or streaming and manipulation as well as on the management of digital media contained in the invention for review.

In Local Review mode a user is able to select a file for playback, and then control buttons to control playback and rendering of media content on their own displaying device. The invention is built so that certain control GUI objects cannot be pushed twice, unless their functionality is overwritten by another functionality GUI object. For instance, if the user hits the play button, they cannot push play again, unless they hit the stop or reset buttons. The user may stop playback, fast forward, or rewind the media, if the media file allows for these types of functionality. The user may also select “loop”, which will allow the media file to automatically be played back from it's beginning, once it has come to it's end. A user may select another media file while the current one is playing. This will cause the currently playing media to stop and instruct the media management component to load the new file into the media review tool. The user may then select play to begin playback of the new file. The user's ability to select a file, or play it may be governed by the user role or authority that has been assigned to them. For instance, a manger type user, if it is not the immediate user themselves, may select the role for another user to be a manager, which may give them use of all functionality rights within a particular shared area, or the user may select a role such as Guest, which may or may not give them any or some functionality rights.

Team Review Mode: is defined by the invention functionality that is enabled when collaboration participants choose the “Team Review” mode within the invention. This mode enables a user to select a file from a file listing for loading and playback, and with the aid of the invention, signal another participant's local invention to repeat the same action. When one user selects Play, the platform will tell the other installations, to complete the same action. The invention has been designed in such a way for ease of media playback in a multi-user mode. When a file is loaded for playback and then is playing back, other users may not select and load a new file until the current file has stopped playing. This allows for ease of playback and user management when groups of people are reviewing. When one user triggers playback, the Play button will become disabled on everyone's machine. All local playback functionality and behavior is mirrored on everyone's machine. The preview mode of the invention may allow users to have unlimited file playback, but they will not be able to participate in Team Review mode.

File Loading: In both Local or Team review mode, when a participant adds a file to an invention's installation media data storage area, it will be replicated to all other users who have the invention installed and are invited or active with the user in the same realm or virtual “room”. The invention may include a feature that saves the file into an auxiliary local database and does not allow files to be sent to other users.

Auxiliary functionality: Auxiliary functionality can include but is not limited to the functionality listed in 019 and 029. This functionality will be enabled in purchased versions of the copy and may or may not work in Local and/or team modes. For instance, a P2P collaboration threaded discussion application would work in a collaborative fashion regardless of whether the workspace participant(s) are in Team Review mode. When a user leaves a message in a P2P collaboration threaded discussion application, the P2P collaboration platform will take care of making sure the other users who have access to the collaborative application, either through their purchased version of the software, or because they have viewing rights set in the installation, are able to see the message and respond to it. Other functionality may include Team Review mode, which might include some form of media editing technology or other functionality that would be applicable to run in both Local Review and Team Review modes depending on needed use.

Method of using a combination of the invention's license information storage container and its related major component with the underlying P2P communication and user invitation system to achieve horizontal software distribution propagation of the invention's general and remote controlling features to non-owners or non-registered users of the invention:

By utilizing the underlying P2P system's data replication, mirroring and automatic installation mechanism in combination with the invention's licensing component's automated license management and status retrieval features, we allow the invention's remote controlling functionality to be extended and installed seamlessly to known peer users within the P2P collaboration system—by the mere process of a P2P system's provisioned procedure of electronic invitation, as outlined in 011, the general description of a possible P2P collaboration system. Therefore, upon user or programmatically triggered action, the invention is enabled to self-replicate and self-install to new peers (e.g. cross-organizational) for instantaneous use, while guaranteeing the inventor's ability to oversee and regulate the invention's distribution package usage and automatic mode switching.

Consequently, beyond the enablement of locally and remotely controlling the display of media content on one's own and other users display devices, the invention extends conventional and traditional software licensing mechanisms by automating not only the proliferation of a software application from user to user, but also by delivering full application functionality to every invited user from the point of installation, while putting a newly invited end user in complete control over the decision of when to purchase a full license to fully utilize all features of the invention or for how long to work with just a subset of them.

An exemplary automated licensing and electronic license management system would include the ability, but not be limited to support or enable the invention's licensing component in executing the following features to:

Control Modes and Functionality: Create demos, rentals, pay-per-use applications. Immediate software activation via phone, fax, e-mail, or the Internet. Extend a demo, rental, or lease for an additional period of time. Turn on one or more menu options or applications in a suite. Convert application from single-user mode to multi-user mode. Protect using either fixed or floating network licensing. Modify the number of allowed network workstations. Convert from a preview, to a “lite” or “full” version, or to any level of functionality enabled versions. Increase or decrease a counter. Trigger any user-defined action.

Enforce License Compliance: Lock the application to run on the current computer or network server only. Limit the number of allowed network users or computers. Terminate rental or lease applications that are not paid. Turn an illegal copy into a demo or disable it. Force returned software or fraudulent purchases to stop working.

Other Features: Detect click backdating or demo reinstallation to gain additional usage. Encrypt/decrypt user data. Personalize and/or serialize without recompiling.

License information storage containers: License information storage containers may be files that contain many data fields that allow for storing of information to control the flow of execution in an application. The fields can be initialized before sending an application using a License information editing application and/or can be manipulated by an application remotely using special data exchange codes that trigger certain events in an application. Such files may be stored in a regular file in any directory, an operating system's registry, any type of hardware dongle, an Internet Web Server, or any other type of storage location. There may be many character string, numeric/bit, and date fields in the license information storage container. Data ranges from pre-defined fields such as serial number, expiration date, and number of allowed network users, to user-defined fields.

Data exchange codes for automatic and remote user mode switching control: The licensing system may have a mechanism to send one-time secure remote signals (data exchange codes) to an application while running on installation device. Upon user's contact with the invention vendor or manufacturer, they may, after receiving user provided information, such as purchasing information or application ownership validation information manually or automatically give the user a series of data exchange codes or remote data signals transmitted over a network to perform certain predefined functions within the invention's installation at a user's site. In addition to the remote signal sent, a encrypted number can also be sent. This encrypted number could contain data such as the number of allowed workstations, number of pay-per-use events, etc.

Copy Protection: When copy protecting an application, the system may allow for authorizing a particular computer or network using different Computer ID number algorithms provided by the system's API. The licensing system may include library functions for hard-coded inclusion into the invention's source code that detect illegal copies of a protected application. Upon detection, the application vendor may convert the application to a demo, abort the program, or convert the application to another mode.

Payment/Rentals/Lease Option: For rented/leased applications or technical support clients, the system may allow for enforced periodic suspensions. This feature could be used to guard against fraudulent credit cards or X-day money back guarantees. When the software is purchased, it can be activated but requires an additional authorization in X days.

Demo Creation: The licensing system may enable distribute of demo copies of the application. Using the licensing system can cause the application to stop working after a specified date or number of executions or other defined conditions. The system will not allow more use of the application by backdating the system date or reinstalling the demo. The system would allow for some or all of the features of the application to be enabled during the demo period.

Network Per-Seat Licensing: The licensing system may prohibit the copying of software from a server hard drive, limit the number of simultaneous workstations, or assign the application to specific workstations. In most cases, the licensing system can detect when any of the client stations terminated prematurely and automatically free up the license that was being used.

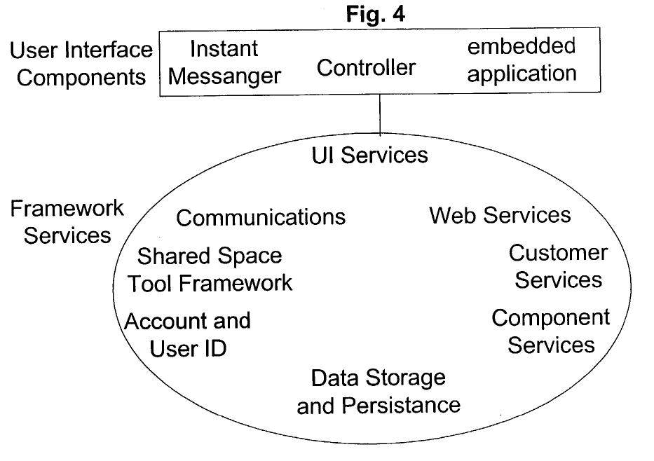

An exemplary P2P collaboration environment in which the invention would be deployed will provide for a minimum of two levels of services as depicted in FIG. 4: user interface components and application framework services that allow for a coordinated and controlled functioning of all involved components; those that are an integral part of the P2P system as well as external or embedded components that comprise the invention.

Actual tasks and responsibilities handled by the P2P framework services will include aspects of communication, user interface rendering, component installation and removal, user data management, installed applications management, customer support services, collaboration management (spaces) and data storage and persistence.

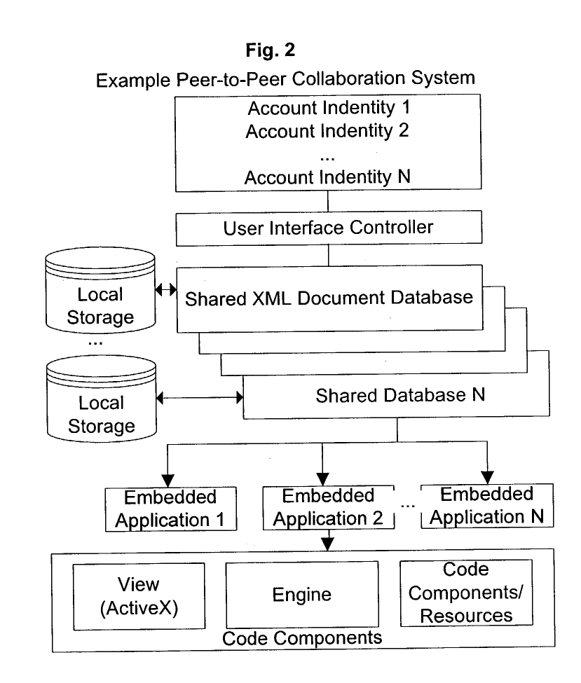

The interconnection of users' identity representation, persistence of user information and application data and the relation of interacting components in a model-controller-view model are represented in FIG. 2.

The exemplary P2P collaboration application framework functioning as a foundation for the invention to operate in would adhere to the following definitions of key terms, architectural and functional aspects of P2P based environments:

Peer-to-Peer communications are between peers whenever possible. Users communicate directly with other users, without servers. This significantly reduces server-based security, network administration, and availability requirements.

Network flexibility would be designed to function in a variety of networks, some of which are popular today, others that may be more popular in the future. The platform could be used over the Internet, on intranets, on private networks (such as a private home), on wireless networked devices, and on a LAN. The system may also handle both connected and disconnected users

Efficient protocols: The underlying protocols would be unidirectional and efficient, so eventually it could be used on small devices such as PDAs and cellular phones. These protocols allow transmission and receipt of data without any network configuration.

Flexible, efficient development may be based on component and distributed component software models, such as but not limited to DCOM, COM+, EJB, JAVA, CORBA, .NET.

Asynchronous operation: Most networked applications do not update asynchronously. For example, a user must “refresh” their document to view new content. The platform would be designed to work asynchronously so users receive and send updated information in real time. This also would allow background operations to proceed without interrupting User Interface interactions.

Robust: The Customer Services subsystem should gather information related to the P2P framework's failures and repair or replace any components that are not functioning properly. Components could be diagnosed remotely, and repaired or replaced dynamically. This would allow for automatic process cleanup and recovery, too.

Standard, efficient Storage may be based on XML. Such an extensible format would allow device independence and interoperability. Of equal importance, using XML would allow the platform to take advantage of new applications for creating and editing XML as they appear. The platform would support a variety of robust data structures, including hierarchical records, binary documents, and non-string data types. The platform's support for logging would allow for recovery, and indexing schemes can be used for storage efficiency optimization.

Secure: Data created in the platform should be secure, both on disk and during transmissions. Security maybe available by default, and would be automatic and transparent. The platform may support encryption technologies such as public key technology for user authentication, secret keys to ensure confidentiality and data integrity, and signing for components. The platform's flexible, powerful security system would allow users to choose the level of security (confidentiality, authentication, integrity, etc.) appropriate for their interaction. This architecture would also allow security-conscious organizations or individuals to opt for whatever level of security they desire. The platform would have built in support for strong cryptography end-to-end because of recently relaxed export restrictions.

Multi- and cross-process support: The platform should have a multi-process architecture, but also support single-process operation. The platform would allow cross-process operations and allow flexible packaging for applications using the platform's services, and robust, transparent cross-process event notification and storage sharing.

Componentized and extensible: Extensibility would allow the platform's components to be re-used and/or replaced.

Transaction support: The platform's transactions should be atomic, consistent, isolated, and durable (with respect to the platform itself), and are operation-independent. Transactions are cross-command, not cross-database.

An exemplary P2P application framework would consist of a top-level user interface that may be called a controller, and individual shared applications called embedded applications. The controller would provide local system-level functionality, such as communications, security, and user identity or account maintenance. A single controller instance, could host any number of shared realms or virtual working spaces that can be in use at one time. Each one of these shared realms hosts one or more embedded applications. An embedded application would be composed of components that adhere to a Model-Controller-View architecture paradigm. One embedded application could contain other nested embedded applications, and also may contain a view of another embedded application's data. The shared realm's “object model” could be exposed via properties where spaces create the runtime environment for tools. Controlling code would provide the controller and overall application logic, whereas an engine would perform all data model access and manipulation. The embedded application component architecture could be summarized as a “mediated model/view/control” architecture, where all data changes are funneled.

The persistence of a shared realm could be captured in a hierarchical database or collection of documents, which may be of XML format, that define data and views of data. Each shared space would manage various collections of documents that serve specific purposes. Each embedded application's data model access engine would maintain persistent data with a document unique to it. An application section would contain engine-specific model data. Dynamic parts of a shared realm document would contain the data corresponding to the units of change in the system. In such realization of a MCV model, a view would be responsible for user interface interaction, whereas controlling code would handle events in response to a user interface interaction and an engine would be responsible for the embedded application's data model. Here the P2P application framework architecture model would be similar to a “model-view-control” architecture used in asynchronous component-based systems. The P2P platform could provide a “mediated” model-view-control architecture by layering a shared realm embedded application framework on top, which would work in conjunction with the embedded application's engine to coordinate local and remote changes to the data model, and maintain consistency through bundled instruction sequences. Such architecture would allow execution of change units to occur asynchronously, which means that a P2P platform would not need to “lock” a device until certain data is processed.

An exemplary P2P platform's reusable user interface components could include instant communication, the platform's controller, and individual embedded applications. Instant communications provides instant, ephemeral communications such as chat, voice chat, and instant messaging. Instant communications also provides a means for distributing shared space invitations. The controller would provide access to system capabilities, such as shared realm management (creation, deletion, etc.), user account management, and searching, where the user interface for these features could be provided by dedicated embedded application like the invention.

Such P2P application framework could be made up of a number of system components that interact to provide services to reusable user interface components where system components function independently of user interface components. User interface components may be “unaware” of what a system component is doing. An example of this would be how a communications subsystem is choosing to distribute data among shared realm users. An embedded application would then not need to know how the data is being distributed; it would only need to get the data to the proper component (in this example, the communications subsystem).

The P2P collaboration framework's realms would rely on a storage subsystem that could maintain an XML documents database, which may be implemented by using an XML document object model abstraction and serialization format, that contains all data for each shared realm. The P2P platform would store all user-generated data in a storage services database. These databases could map to one or more files in a native operating system file system. Such a exemplary storage subsystem would maintain concurrency without overlapping lockouts, and supports multiple document types and schemas. It may also use other storage services. Storage services may have specific mappings to their databases.

In order to provide the necessary data management and dissemination support for the invention, the P2P collaboration framework's storage subsystem should be designed to meet the following goals: Provide a consistent in-memory and persistent data model in XML, Use distributed shared memory to support multi-process, and potentially multi-computer use, Provide robust and recoverable data storage, Provide efficiency and flexibility for different storage models and machine architectures.

To achieve the above stated data integrity goals 072, an exemplary P2P application framework would make use of a storage management component, which could be a memory-resident for every instance of the P2P collaboration platform's installation. Such a storage management component would be responsible for maintaining the integrity and consistency of all documents, both persistent and running for all services and shared realm's on a user's machine. It would receive records from all users in a shared realm and update its data stores in real time. Further, a storage component security manager would guarantee that all data becomes encrypted before being stored. In this regard, such storage services would not be triggered by events but rather provided on demand.

The Platform's data and document schemas could specify bindings, define attributes, and provide indexing. Such a storage management component could index certain elements, for example, strings, dates, and integers. It would support different document types (binary, collections, etc.) and allow links (both inter and intra-database), and allow the use of special data types, even within documents.

To facilitate successful distribution, dissemination, propagation and installation of the invention's distribution package, an exemplary P2P application framework would provide for a component services subsystem, in which each component could be defined as any file for which a description can be written, in adherence to an Open Software Description (OSD) standard and where a component must be retrieved, installed, or updated by the component manager in order for the invention to operate properly within the context of the enabling P2P application framework. Examples of supported components could be a DLLs, OCXs, Javabeans, Images or JPEG, GIF, or other formats or other OSD files that describe other nested component installation hierarchies.

Such component services subsystem would use a “dependency tree” of components and component versions as identified by an OSD document. The exemplary P2P platform would provide for a flexible subsystem for hosting these components, which may include but not be limited to public Web servers, so that users do not have to keep track of versions or upgrade manually.

Such component services subsystem would manage and simplify loading and updating platform code and resources from a variety of sources, including Web-based component farms (HTTP or FTP servers) and peers. It could identify the source location for all components via URLs and detail the required version dependencies, and also implement component security such as authenticity and integrity. In addition, the component services subsystem may support component versions such as limited-use embedded application (which then might only be available in a single shared realm) or embedded application that “expire” after a period of time.

The way such component sub-systems could work is that when it loads, it checks the version of the loaded components against the version recorded in a shared realm component descriptor. If it identifies a different version, it would then automatically determine the proper component retrieval source and download the required component. Such component services would also allow the P2P collaboration platform to support the invention by automatically retrieving and installing components or embedded applications based on the type of data added to a realm. Such component services may initiate an action in response to a user gesture (for example upon uninstall of an embedded application), or it may act automatically (for example, to update a P2P collaboration system's component).

An exemplary P2P collaboration framework's support of horizontal propagation through a defined component update process. A component update request would signal the component manager that some entity needs a specific version of a component, which could be through the process of invitation. This request could originate from a remote user, from a local user in response to instantiation of an embedded application, or if an installed component requires updating. A component update request could then trigger a four-step (build, download, verify, and install) component update process. The build, download, and verify phases may occur asynchronously and may not be triggered by, nor would they require, user action. An install step, however, may occur as the result of a user action. An exemplary component services subsystem would include components such as a component manager, a download manager, and an install manager.

Although the exemplary collaboration platform would be a peer-to-peer based application framework, the Internet would play an important part in its overall architecture. This P2P platform would use the Internet for communications, relay, component storage, among others, and the Internet would truly be a “part” of the platform.

The P2P collaboration platform's Internet based Web services could be separated into conventional services and custom services. Conventional services could use off-the-shelf technologies such as replication, standard protocols, and databases. A conventional service would be a database of customer addresses and phone numbers. Custom services of the P2P platform, for example a relaying service or a Device Presence Protocol server, are relay-based services and may use proprietary technologies developed by the P2P collaboration platform's vendor. An example of a custom service would be a database of change units that are to be relayed to a specific user.

This is a list of possible Web services the P2P platform could provide: relaying (object queues, fan-out, and presence), device presence protocol servers, E-commerce applications and billing, Application servers, Component downloading, Event reporting, and statistic collection and monitoring, SOAP transactions (may form the substrate for some of the above services), Critical resources backup, user web pages, providing account and shared realm backups, contact management and searching, and additional services and products.

Security: A security subsystem component would provide security services as required by other parts of the P2P collaboration platform or its embedded applications, such as the invention. The P2P platform's possible security infrastructure would provide and manage all aspects of security for users and realms. It would allow for all data (both during transmissions and on disk) to become and stay confidential. It would provide for authentication services, so that membership in shared realms could be secured. It also would verify the integrity of data for all users. It would further provide a mechanism by which application framework developers could implement authorization and user roles.

To support the invention's functionality in remote controlling other users' playback and display devices and to allow for horizontal propagation of the invention distribution package while binding each installation of the invention to a specific, identifiable user, an exemplary P2P collaboration platform would provide the invention with mechanisms for communications and presence detection.

There are two aspects to presence: device presence and user presence. Device presence indicates the availability of the users or accounts on a particular device. User presence indicates the availability of a particular user account or identity on any device. An exemplary P2P platform could use a type of device presence protocol (DPP) to establish device availability, and some peer-to-peer version of a Rendez-Vous Protocol (RVP) to establish user availability, where the embedded application would subscribe to user availability, while the P2P platform application instance would subscribe to device availability.

User Presence Services: In order to properly route data to a user or an identity, a P2P platform's exemplary communications subsystem must be capable of locating information about a user (Contacts) and determining their availability. For this purpose it would use certain presence services to locate the target of a data transmission (for example an invitation to join a user with the context of a realm or virtual room or unit of change transmission) through RVP. The P2P platform's version of RVP may be server-less, so that no central server or authority would know who is online at any time. An example communications manager would open and maintain Simple Symmetrical Transmission Protocol (SSTP) sessions with other members within a shared realm. It would manage dynamic sessions both between directly connected peer users and through platform based relays.

The RVP service on a user side would determine and stores information about the availability of all of a user's contacts. Whenever a user's availability (online status) changes, their account (through the account subsystem, RVP service, and communications subsystem) would notify the presence service on all of their subscribers' devices of the change in status. In addition, each device's presence service could then poll all of its peer contacts to determine availability. One device's user presence services feature may also provide a subscription service to other devices. In this case, a presence server would notify each subscribing contact of every change in its availability. The user presence service could send status notifications to subscribing contacts in any combination of the following cases: when it receives a status change notification from another device that wishes to send a message, when another device connects to the network, or when any other device changes its availability. A Microsoft specific version of such system may for example interface with the Microsoft Winsock API to send and receive messages over the network, or it may make use of 3^{rd} party or proprietary APIs to achieve the dissemination and reception of messages.

Device Presence Services: To establish device availability, the exemplary communications subsystem of the P2P collaboration platform would subscribe to the device identifiers, which may be in URL or URI format, of all endpoints in all of a user's shared realms, and then translate these into physical addresses, which may be Internet Protocol (IP) addresses or any other type of network identifiers. It may provide an interface between a transport subsystem (which would manage transmission of change units and their reception), and the P2P platform's further components such as an identity subsystem, RVP clients, dynamics subsystems, and others.

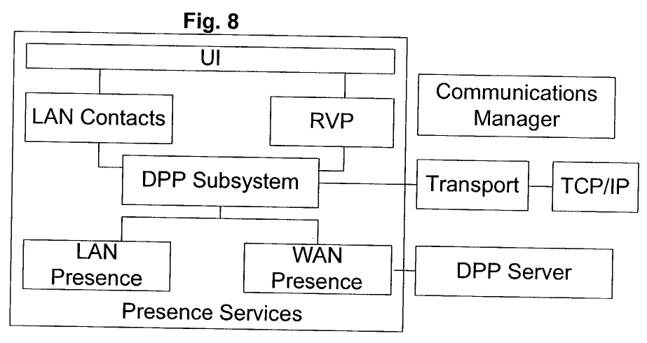

Device Presence Services would use a DPP to establish the online status of devices on which application instances of the P2P platform are installed. Presence services would then facilitate communications for user accounts and identities, but may not directly be connected to those processes. Presence services could use, but may be limited to the UDProtocol to transmit short binary messages directly between devices on a subnet, and SSTP to communicate with the P2P platform's WAN presence services. DPP would enable direct communications between platform-enabled devices. In a case where direct communications are not possible, communications could use the platform's relay. DPP provides an abstraction of two services: LAN (Local Area Network) presence, which indicates presence of the platform's users on the user's LAN subnet, and WAN (Wide Area Network) presence, which indicates presence information for a user's contacts. This is shown in the FIG. 8.

A number of current methods features, implementations and possible expansions of implementations by means of adding auxiliary functionality into the provided and prepared system architecture slots have been described above. Nevertheless, it is understood that various modifications can be made. For example, advantageous results still could be achieved if steps of the disclosed techniques were performed in a different order and/or if components in the disclosed systems were combined in a different manner and/or replaced or supplemented by other components. Accordingly, the current and other implementations are within the scope of the following claims:

We claim:

1. A method for enabling line users to collaboratively review and remotely control playback, status information, file sharing and streaming of digital media on and to other users within a communication and collaboration system that adheres to peer-to-peer or hybrid peer-to-peer computing infrastructure paradigms, comprising the steps of:
a). determining by computer users whether an on-line user is available for receiving communications.
b). inviting one or more online users to collaboratively review digital media on their computers.
c). loading in digital media storage of the computer of the invited online user(s) said digital media upon acceptance of the invitation by the invited online user(s).
d). receiving a control signal from one or more of the invited online user(s), said control signal controlling the display of said digital media on another online user's computer.

2. The method of claim 1 wherein said control signal controls the display of said digital media on one or more invited online user's computers and the computer transmitting the invitation to one or more online users.

3. The method of claim 2 wherein the control signal synchronizes control of the digital media on all invited, and accepted, online user's computers and the computer transmitting the invitation to one or more online user.
